(19) United States
(12) Patent Application Publication
(10) Pub. No.: US 2026/0012231 A1
(43) Pub. Date: Jan. 8, 2026

(54) Beam Steering Based on Predictive User Location in a Microcell Network

(71) Applicant: DISH Wireless L.L.C., Littleton, CO (US)

(72) Inventors: Dhaval Mehta, Aldie, VA (US); Gurpreet Sohi, Parker, CO (US); Sourabh Gupta, Ashburn, VA (US)

(21) Appl. No.: 19/070,981

(22) Filed: Mar. 5, 2025

Related U.S. Application Data
(60) Provisional application No. 63/667,477, filed on Jul. 3, 2024.

(51) Int. Cl. H04B 7/0426; H04L 41/16; H04W 28/24

(52) U.S. Cl. CPC H04B 7/043; H04L 41/16; H04W 28/24

(57) ABSTRACT

Techniques are described for enhancing microcell (e.g., cellular) performance in environments with diverse and dynamic network demands. For example, microcells equipped with distributed units (DUs) and intelligent controllers leverage machine learning (ML) to anticipate and respond to network conditions. Features include predictive user equipment (UE) reallocation and beamforming for targeted signal optimization. Microcells dynamically adjust configurations to maintain quality of service (QoS), prioritize critical UEs based on service level agreements (SLAs), and optimize resource allocation.

### CROSS REFERENCE TO RELATED APPLICATIONS

This application claims priority to U.S. Provisional Patent Application No. 63/667,477, filed on Jul. 3, 2024, the disclosure of which is incorporated by reference in its entirety for all purposes.

### BACKGROUND

Cellular microcells can be used to provide cellular network service to multiple user equipment (UE) operating in a particular environment. Certain locations may tend to have much higher concentrations of UE. These UE may be used by unrelated parties, such as different persons in a mall or stadium or may be operated by a single entity, such as pieces of equipment in a factory or warehouse. Such large numbers of UE operating in a dense environment can create a challenging scenario in order to meet defined Quality of Service (QoS) parameters while operating the cellular network microcells in the environment efficiently.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates a block diagram of an embodiment of multiple cellular microcells installed in an environment.

FIG. 2 illustrates an embodiment of a cellular network core.

FIG. 3 shows a flow diagram of a method for managing quality of service (QoS) in a microcell network comprising a plurality of collocated microcells, according to some embodiments described herein.

FIG. 4 shows a flow diagram of an illustrative method for predictive per-antenna beam steering in a microcell network, according to some embodiments described herein.

FIG. 5 illustrates a block diagram of an embodiment of multiple cellular microcells providing cellular service to multiple user equipment (UE) in an environment.

FIG. 6 illustrates a block diagram of an embodiment of multiple cellular microcells providing cellular service to multiple UE in an environment using intelligent control and scheduling.

FIG. 7 illustrates a block diagram of an embodiment of multiple cellular microcells providing cellular service to multiple UE in an environment using intelligent control and beamforming.

FIG. 8 illustrates a block diagram of an embodiment of multiple cellular microcells providing cellular service to multiple UE in an environment using intelligent control, beamforming, and power savings.

### DETAILED DESCRIPTION

Cellular microcells can provide cellular network coverage over a smaller region that conventional cellular network base stations. Cellular microcells can be deployed to provide cellular network coverage or improved cellular network coverage for a particular environment, such as within an indoor or in an outdoor environment. Examples include shopping malls, factories, stadiums, casinos, festivals, warehouses, downtown districts, convention centers, shipping yards, etc.

In an environment where multiple cellular microcells are deployed, varying situations may be present and may tend to repeat themselves. For example, referring to a shopping center or mall, particular areas of the mall may tend to be busy at particular times of day and days of the week. For example, a food court may be especially busy at lunchtime. Referring to a factory, a particular production line may tend to be run on weekday mornings and thus may tend to require significantly more cellular network bandwidth during those times but use little bandwidth when the production line is not operating.

As detailed herein, microcells can be improved to intelligently anticipate and respond to changes in conditions. A cellular microcell, which may use 5G New Radio (NR) as its radio access technology (RAT), can have an on-board distributed unit (DU). An on-board distributed unit can provide local control of the microcell's one or more radio units (RUs), including performing scheduling of communications. The processing system that hosts the functionality of the DU can also provide additional functionality by hosting an intelligent controller that can include a machine learning (ML) model that has been trained on how the cellular microcell (and possibly other microcells in the same environment) can be reconfigured to provide more optimized cellular network service. Providing more optimized cellular network service can include: improving performance provided to some or all UE serviced by the cellular microcells; improved performance in meeting QoS parameters specified for particular UE's service level agreements (SLAs); reduced power consumption; reducing interference; and/or providing service to UE that could previously not be serviced by the cellular microcells.

Notably, the use of machine learning by the intelligent controller can allow for the cellular microcells to preemptively adapt to expected conditions of the environment of the cellular microcells. Therefore, in anticipation of one or more particular microcells experiencing a significant increase or decrease in traffic, actions can be taken by the intelligent controller to help ensure that quality of service is maintained for the UE in accordance with QoS parameters defined for the individual UE. As detailed herein, UE can be preemptively switched to receiving service from a different microcell, beamforming can be performed to improve service in particular directions, certain UE can receive preference in scheduling, coordinated multipoint communication can be used, or some combination thereof.

Throughout this document, each cell is referred to as a microcell, or small cell. It should be understood that “microcell” and “small cell” are used interchangeably and can be generalized to include other forms of cells, including macro-cells, femtocells, picocells, small cells, etc. Further, embodiments described herein are not intended to be restricted to cellular microcells or cellular core network functions. The microcells may include other forms of wireless communication nodes, such as Wi-Fi access points, satellite communication nodes, or hybrid systems combining multiple wireless technologies. Similarly, the core network may encompass non-cellular architectures, such as enterprise intranet backbones, private network infrastructures, cloud-based communication systems, or satellite-based networks. For example, in a factory environment, microcells may include Wi-Fi nodes for local area connectivity, while the core network may be a private industrial network utilizing edge computing resources. In another example, a remote outdoor event may deploy satellite communication nodes as microcells, with the core network hosted on a cloud platform. These alternative implementations allow the disclosed techniques to apply broadly across various communication systems, ensuring optimized performance and resource utilization regardless of the underlying network architecture.

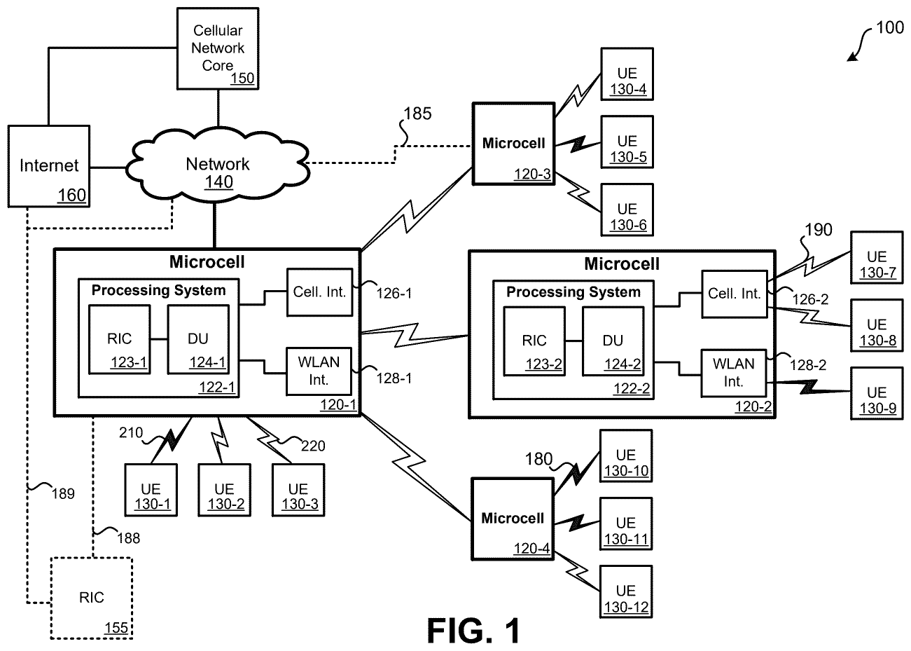

Further detail regarding these and additional embodiments are provided in relation to the figures. FIG. 1 illustrates a block diagram of an embodiment of a multiple cellular microcell system (“system 100”) installed in an environment. System 100 can include: cellular microcells 120 (“microcells 120”); UE 130; network 140; cellular network core 150; and Internet 160. UE can be any form of computerized device that accesses either Internet 160 and/or cellular network core 150, such as smartphones, Internet of Things (IoT) devices, gaming devices, smart factory equipment, smart sensors, smart security equipment, computers, cellular modems, or local access points (e.g., hotspot devices) to which other devices can connect.

In some architectures of system 100, microcell 120-1 serves as a primary microcell through which the other microcells of microcells 120 (e.g., microcells 120-2, 120-3, and 120-4) connect with network 140. Microcell 120-1 serves to communicate with one or more other microcells 120 and interface with network 140. Microcell 120-1 can use a wired connection to network 140. In some embodiments, this wired connection is a high-speed wired connection to an Internet Service Provider's (ISP's) network. For example, an optical fiber connection may be made to network 140. Via network 140, microcell 120-1 can communicate with Internet 160 and cellular network core 150. Cellular network core 150 can be hosted on a public cloud computing service or may be operated on a privately managed server system. All cellular traffic with microcell 120-1 and other microcells of microcell 120 by UE 130 can be routed to cellular network core 150. As needed, cellular network core 150 can access Internet 160, which can occur through one or more firewalls and can be performed by a user plane function (UPF) of cellular network core 150.

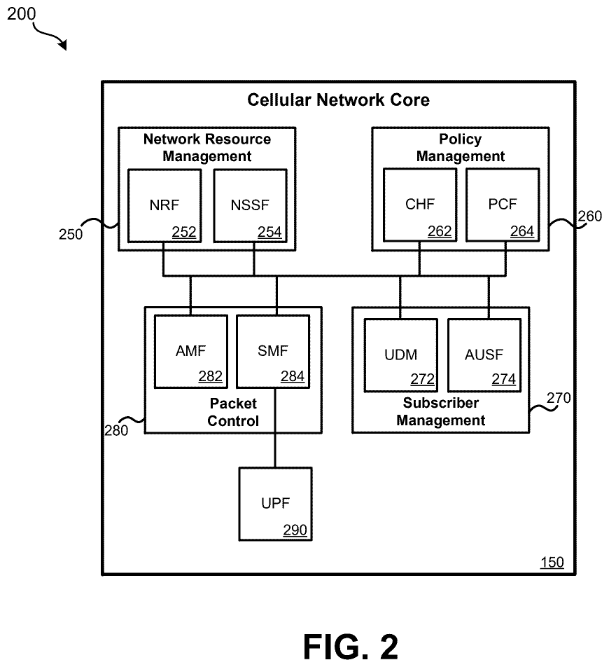

Cellular network core 150 can provide core cellular network functionality. Components of cellular network core 150 can include: network resource management components; policy management components; subscriber management components; and packet control components. Cellular communications with a UE of UE 130 that require accessing the Internet is performed via cellular network core 150. Further detail regarding cellular network core 150 is provided in relation to FIG. 2.

Microcell 120-1 can: 1) communicate directly with UEs via a cellular communication protocol; and 2) communicate with other microcells via the cellular communication protocol. Microcell 120-1 can aggregate communications for all UE with cellular network core 150. In other embodiments, microcell 120-1 may not communicate directly with UEs. As shown, three UE (130-1, 130-2, and 130-3) are in direct communication with primary AP 110 via a cellular communication protocol. The cellular communication protocol can be 5G New Radio (NR). Other cellular communication protocols can be used, such as 4G, 6G, and beyond. Other technologies are also possible, such as wireless local area network (WLAN) technologies, such as WiFi™. From the perspective of UEs 130-1, 130-2, and 130-3, when 5G NR is used as the cellular communication protocol, microcell 120-1 functions as the gNodeB. Therefore, distributed unit (DU) functionality, centralized unit (CU) functionality, and cellular network core access are provided via microcell 120-1. As an example of DU functionality that is provided, scheduler functions are implemented locally to allow for the proper scheduling of communications with UE.

When a UE accesses microcell 120-1 via the cellular communication protocol, the UE's access may be made via a particular cellular network slice. Slicing can allow for particular radio, processing, and bandwidth resources to be reserved for a particular UE or group of UE. As such, different UE can be provided different quality of service (QoS) parameters by assigning the UE to different slices. Accordingly, a UE may be assigned to a slice depending on the importance and functionality of the UE.

Microcell 120-1 can include: processing system 122-1, cellular interface 126-1, and possibly wireless local area network (WLAN) interface 128-1. Microcell 120-1 is shown in direct cellular communication with three UE (130-1, 130-2, 130-3); this is for example only. In other embodiments, fewer or greater numbers of UE may be in direct communication with microcell 120-1.

In this architecture, microcells 120-2 through 120-4 do not have a wired connection to network 140. Rather, microcells 120-2 through 120-4 rely on a cellular communication protocol backhaul link with microcell 120-1 to access network 140. Three additional microcells 120 are shown by way of example; in other examples, fewer or greater numbers of microcells 120 may be present in an environment. The number of microcells used can vary based on the size, load, and interference present within an environment to receive cellular service. For example, a shopping mall may require many microcells to cover multiple stores and floors. As another example, in some architectures, a single microcell may be needed for a relatively open building, such as a warehouse.

UEs wirelessly communicate via a cellular communication protocol (e.g., 5G NR) with microcells 120. From the perspective of UE (130-7, 130-8, 130-9), microcell 120-2 provides gNodeB functionality and access to network 140 (including cellular network core 150 and Internet 160). Microcell 120-2 can receive, transmit, and prioritize communications with UE 130-7, 130-8, and 130-9. UE communications can be prioritized (e.g., according to slices) and transmitted via a backhaul communication channel to microcell 120-1. The backhaul communication channel can use the same cellular communication protocol used for communication with the UE. From the perspective of microcell 120-1, microcells 120-2, 120-3, and 120-4 are treated as individual UE.

In the illustrated architecture of system 100, a hub-and-spoke network topology may be used. In such a topology, each of microcells 120-2, 120-3, and 120-4 has a direct cellular communication protocol backhaul to microcell 120-1. In other embodiments, a mesh or daisy chain topology may be used in which microcells 120 communicate with each other to communicate with microcell 120-1. Regardless of network topology, each of microcells 120 may be physically connected only to power with all communications performed wirelessly.

In FIG. 1, a total of four microcells 120 are illustrated. Fewer or greater numbers of microcells 120 may be present in other embodiments. As shown, UE 130-4, 130-5 and 130-6 communicate with microcells 120-3. UE may move and thus may shift with which microcell in the environment that communication is performed. The number of UE communicating with each of microcells 120 can be greater or fewer than three.

System 100 can have alternative architectures. Rather than having other cellular microcells communicate with network 140 through microcell 120-1, at least some of microcell 120 can communicate directly with network 140. For example, as shown by connection 185, microcell 120-3 may communicate directly with network 140 (e.g., via a wired connection) and, thus, backhaul communications between microcell 120-3 and microcell 120-1 may not be necessary (or may serve as a backup connection). While not illustrated in FIG. 1, microcells 120-2 and 120-4 can also have direct communication (e.g., wired connections) with network 140.

System 200 can also provide WLAN connectivity to UE. WLAN connectivity can be provided to UE via a Wi-Fi family protocol, which is based on the IEEE 802.11 family of standards. Therefore, a UE can use a WLAN connection, cellular connection, or both to communicate with cellular microcells 120.

WLAN communications performed by UE with a cellular microcell of cellular microcells 120 are also transmitted to cellular microcell 120-1 via cellular backhaul communication. Cellular microcells 120 can use a defined prioritization scheme to define how WLAN communications are prioritized in relation to cellular communications. For example, WLAN communications may be effectively treated as a slice in that particular QoS parameters are met, which may be higher or lower than some or all cellular slices.

Once WLAN communications are transmitted by other microcells of microcells 120 to microcell 120-1, microcell 120-1 may translate the communications to an appropriate protocol (e.g., TCP/IP) and transmit to network 140. WLAN communications can be routed directly to Internet 160 by microcell 120-1 via network 140. In contrast, cellular communications by UE 130 via microcells 120 are routed to cellular network core 150, which processes such communications and handles communications, as needed, with Internet 160. In other embodiments, WLAN communications involving the Internet can also be routed to cellular network core 150, which can then access Internet 160. IMS voice communications over the WLAN can be routed to cellular network core 150.

As shown in FIG. 1, some UE are using WLAN communications to access Internet 160, as shown by WLAN communications 180. Other UE are using cellular communications to access Internet 160 through cellular network core 150, as shown by cellular communications 190. UE may also use both forms of wireless communication. For example, a UE may be executing multiple applications: a first application may use cellular communication in order to ensure security and/or that particular QoS parameters are met (e.g., latency, uplink bandwidth, downlink bandwidth, jitter), and a second application may use WLAN communication since security and/or QoS are not as essential to the functioning of the second application.

As shown in FIG. 1, microcell 120-2 may have a WLAN interface 128-2. Microcell 120-1 may have WLAN interface 128-1. In some embodiments, this interface is not present and microcell 120-1 cannot perform direct WLAN communications with UE.

On board microcell 120-1 is processing system 122-1. Processing system 122-1 may include one or more special-purpose or general-purpose processors. Such special-purpose processors may include processors that are specifically designed to perform the functions of the components detailed herein. Such special-purpose processors may be ASICs or FPGAs which are general-purpose components that are physically and electrically configured to perform the functions detailed herein. Such general-purpose processors may execute special-purpose software that is stored using one or more non-transitory processor-readable mediums, such as random-access memory (RAM), flash memory, a hard disk drive (HDD), or a solid-state drive (SSD).

Processing system 122-2 can perform the functionality of distributed unit (DU) 124-1. One of the primary functions of a DU is to perform scheduling of cellular communications with UE that are in communication with cellular interface 126-1. Processing system 122-2 has additional processing resources that are available in addition to that used to perform the functionality of DU 124-1. As such, processing system 122-2 can also perform the functions of a radio access network (RAN) intelligent controller (RIC) 123-1. RIC 123-1 can alter the functionality of microcell 120-1 and, possibly of other cellular microcells 120 within the environment. In other embodiments, separate processing systems may be used for RIC 123-1 and DU 124-1.

Within RIC 123-1, one or more ML models may be trained, executed, or both trained then executed. An ML model may be created using a set of training data that has been mapped to a correct or desired outcome. For example, a set of inputs that defines a network condition can be mapped to a particular action that is to be taken in response. The ML model may be created based on data no specific to the environment of system 100. For example, a cellular network operator may create various ML models that are expected to be useful for particular types of environments, such as shopping centers, warehouses, factories, festivals, etc. These models may then serve as a baseline that can be updated based on usage of the microcells. Alternatively, an ML model can be fully trained at microcell 120-1. This arrangement has a benefit of being trained exclusively on situations that specifically within the environment of system 100.

In some embodiments, the ML models employed include neural networks. Neural networks may be created using either supervised or unsupervised learning. As an example of supervised learning, the neural network may be trained by providing a group of inputs that correspond to truth-tagged or desired outputs. The neural network can then be used to create outputs based on its training. The ML model inputs can include one or more characteristics selected from the following: number of UE in communication with the microcell; amount of uplink data being transmitted by the UE to the microcell; amount of downlink data being transmitted by the microcell to the UE; time of day; day of week; QoS parameters of the UE; slices to which the UE are assigned; and applications being executed on the UE. Outputs of the ML model can include changes to: UE to microsite assignments; changes to scheduling as performed by the DU; beamforming or beam steering data; requests to power up or power down microcells; coordinated multipoint requests, or some combination thereof.

Microcell 120-1 may host RIC 123-1, which can update functionality of each of microcells 120 within the environment. Alternatively, some or all of microcells 120 may host a RIC, such as RIC 123-2, which is hosted by processing system 122-2 along with DU 124-2 of microcell 120-2. In such embodiments, the same one or more MLs may be hosted by each of RICs 123 of microcells 120 or the MLs may vary by microcell. That is, each ML may be trained specifically on data obtained at the specific microcell where the ML is to be implemented.

In other embodiments, a RIC may be hosted remotely from microcells 120. RIC 155 may be hosted by a computing system that is local to the environment in which microcells 120 are present. For example, connection 188 (which can be wired or wireless) may be used to connect a computing device hosting RIC 155 with microcell 120-1. In such embodiments, RIC 155 can access data from microcells 120 to understand the conditions at each microcell. RIC 155 may be accessible via network 140 or internet 160, as shown by connection 189. In some embodiments, RIC 155 may be hosted by a cloud computing platform, such as on the cloud computing platform where cellular network core 150 may be hosted.

In general, although some embodiments herein describe the RIC as being implemented within the microcells, embodiments can additionally or alternatively implement the RIC in more centralized locations, such as within a local server, an edge computing device, or a cloud-based platform. For example, in a shopping mall or stadium, a centralized RIC may coordinate multiple microcells across the entire venue, enabling seamless optimization of network resources and coverage. Alternatively, in distributed architectures, the RIC may be implemented on a hybrid basis, with non-real-time (non-RT) RIC functionality hosted centrally (e.g., in the cloud) for tasks like machine learning (ML) model training and policy management, and real-time (RT) RIC functionality implemented locally within microcells for time-sensitive operations, such as beamforming and scheduling. This division of RIC functionality helps to ensure that both latency-critical and computationally intensive tasks are handled efficiently while maintaining scalability and adaptability to various network environments.

FIG. 2 illustrates an exemplary cellular network core 150. Core 150 can be physically distributed across data centers or located at a central national data center (NDC) and can perform various core functions of the cellular network. Core 150 can include: network resource management components 250; policy management components 260; subscriber management components 270; and packet control components 280. Individual components may communicate via a bus, thus allowing various components of core 150 to communicate with each other directly. Core 150 is simplified to show some key components. Implementations can involve additional components.

Network resource management components 250 can include: Network Repository Function (NRF) 252 and Network Slice Selection Function (NSSF) 254. NRF 252 can allow 5G network functions (NFs) to register and discover each other via a standards-based application programming interface (API). NSSF 254 can be used by AMF 282 to assist with the selection of a network slice that will serve a particular UE (e.g., UEs 130 of FIG. 1).

Policy management components 260 can include: Charging Function (CHF) 262 and Policy Control Function (PCF) 264. CHF 262 allows charging services to be offered to authorized network functions. Converged online and offline charging can be supported. PCF 264 allows for policy control functions and the related 5G signaling interfaces to be supported.

Subscriber management components 270 can include: Unified Data Management (UDM) 272 and Authentication Server Function (AUSF) 274. UDM 272 can allow for generation of authentication vectors, user identification handling, NF registration management, and retrieval of UE individual subscription data for slice selection. AUSF 274 performs authentication with UEs.

Packet control components 280 can include: Access and Mobility Management Function (AMF) 282 and Session Management Function (SMF) 284. AMF 282 can receive connection- and session-related information from UEs and is responsible for handling connection and mobility management tasks. SMF 284 is responsible for interacting with the decoupled data plane, creating updating and removing Protocol Data Unit (PDU) sessions, and managing session context with the User Plane Function (UPF).

In some embodiments, coordination with core network functions, such as the NRF, PCF, and AMF, is performed through standardized APIs. These interactions allow microcells to request updated resource allocations, slice adjustments, or policy changes, for example, based on detected dynamic QoS degradations.

User plane function (UPF) 290 can be responsible for packet routing and forwarding, packet inspection, quality of service (QoS) handling, and external PDU sessions for interconnecting with a Data Network (DN) (e.g., the Internet). For example, when a UE of UE 130 attempts to communicate with the Internet via cellular communication, the request may be routed through UPF 290.

Per-User and/or Per-User Category QoS

In one set of embodiments, per-user or per-user-group (e.g., user category) tracking and improvement of quality of service (QoS) is provided. In some cases, the QoS is provided based on predefined service level agreements (SLAs). In existing Open Radio Access Network (ORAN) architectures, a particular user equipment (UE) is typically identified using different identifiers across various nodes due to the heterogeneous nature of the network components and the protocols they employ. Each node within the network—such as microcells, distributed units (DUs), centralized units (CUs), and core network functions—may assign and use its own local identifier for the same UE. This fragmentation arises because each component is designed to perform specific functions and may operate using different layers of the communication protocol stack.

For example, at the radio interface level within the microcells (e.g., microcells 120 in FIG. 1), the UE might be associated with a temporary identifier used for scheduling and resource allocation by the DU 124. At the core network level, the same UE is identified using permanent identifiers like the International Mobile Subscriber Identity (IMSI) or the Subscriber Permanent Identifier (SUPI). Additionally, when the UE moves between microcells or connects through different slices of the network, it may be assigned different identifiers corresponding to the specific network slice selection function (NSSF) 254.

This lack of a unified identifier can complicate consistent tracking of the UE across the network. For example, without a common identifier, it can be challenging to correlate data and performance metrics collected at different nodes for the same UE, which can hinder the ability to monitor and manage the UE's quality of service (QoS) effectively. As a result, implementing per-user or per-user-group QoS management based on predefined service level agreements (SLAs) becomes difficult, as the network cannot accurately enforce policies or make informed decisions to adjust resources in real time.

Moreover, the inconsistency in UE identification can impact advanced network functions such as intelligent congestion management and predictive resource allocation. As described herein, some embodiments use AI/ML models hosted on the RAN Intelligent Controller (RIC) 123 to recognize patterns and trends of users served within the environment. Such models rely on data that can be correlated, compared, etc. to recognize such patterns and trends. If the UE cannot be consistently identified across nodes, the AI/ML models may not accurately detect congestion causes or predict user behavior, reducing their effectiveness in optimizing network performance.

Embodiments introduce a common identifier for each UE across the entire network to support consistent tracking of UEs across nodes. The common identifier can be referred to herein as a unified network identifier (UNI). The UNI enables seamless coordination among microcells, DUs, CUs, and core network functions, facilitating real-time data correlation and more effective QoS management. Consequently, the network can intelligently adapt to changing conditions, such as adjusting microcell configurations for beam pointing and shaping or reallocating resources based on user priority as defined in their SLAs.

The UNI can be generated in any reasonable manner such that the resulting UNI facilitates a UE to be used consistently across multiple different types of nodes in an Open Radio Access Network (ORAN). In some embodiments, the UNI is generated by utilizing standardized permanent identifiers such as the International Mobile Subscriber Identity (IMSI) or the Subscription Permanent Identifier (SUPI). By using the IMSI or SUPI as the UNI, nodes can consistently recognize and manage the same UE throughout the network. However, directly using these identifiers may raise privacy concerns, as they can expose the subscriber's identity if not properly secured.

In other embodiments, the UNI is generated by implementing a Subscription Concealed Identifier (SUCI), which is a privacy-preserving identifier derived from the SUPI using encryption methods. The SUCI allows the network to identify the UE without exposing permanent identifiers, enhancing security while maintaining consistent identification across nodes. Alternatively, the UNI can be assigned as a Globally Unique Temporary Identifier (GUTI) coordinated across nodes. By synchronizing GUTI assignments, the UNI serves as a temporary identifier recognizable throughout the network, facilitating consistent UE tracking.

In some embodiments, the UNI is generated by combining multiple identifiers into a composite identifier. This composite can be created by merging standardized identifiers such as the IMSI, device serial numbers, or MAC addresses, and then hashing them to produce a unique and secure UNI used across all nodes. This approach helps to ensure privacy by not exposing the original identifiers. For example, the UNI can be generated by applying secure hash algorithms on permanent identifiers. Secure hash functions are applied to permanent identifiers like the IMSI to generate a non-reversible hashed UNI. This hashed identifier is consistent across nodes and protects the original identifier from exposure, balancing consistency and privacy.

Another approach involves generating the UNI through a network-assigned unique identifier at registration. Upon initial registration, the network assigns a unique identifier to the UE, which is stored in a central database accessible by all nodes. This identifier remains consistent during the UE's session and facilitates tracking and quality of service (QoS) management.

In certain embodiments, the UNI is generated by extending Network Slice Selection Function (NSSF) identifiers to serve as common identifiers across nodes. Since UEs may be assigned to specific network slices based on their QoS requirements, using NSSF identifiers aligns UE identification with the network slicing architecture and QoS management policies.

The UNI can also be generated by employing AI/ML-based identification methods. AI/ML models within the Radio Access Network Intelligent Controller (RIC) analyze patterns of UE behavior and network usage to assign identifiers based on observed characteristics. This method leverages AI/ML to infer consistent identification without relying solely on predefined identifiers.

In other embodiments, the UNI is established using a Public Key Infrastructure (PKI) and digital certificates. UEs are issued digital certificates containing public keys that serve as unique identifiers. Nodes verify these certificates to consistently identify UEs, enhancing security through cryptographic means and integrating with existing authentication procedures. Another option is to implement a centralized identifier mapping function within the network core, such as the Network Repository Function (NRF). This function maintains a correspondence between local identifiers used by individual nodes and the UNI. Nodes query this function to resolve local identifiers, enabling consistent UE identification.

Each microcell, such as microcells 120 in FIG. 1, includes a processing system (e.g., processing system 122-1 in microcell 120-1) that hosts an onboard Distributed Unit (DU) 124 and a Radio Access Network (RAN) Intelligent Controller (RIC) 123. The DU manages local control of the microcell's Radio Units (RUs), performing functions like scheduling communications with UE. The RIC hosts AI/ML models that have been trained to recognize patterns and trends of users served within the environment, enabling the microcells to intelligently anticipate and respond to changes in network conditions.

The AI/ML models analyze data collected from UE, using the common identifier to track individual users or user groups consistently across the network. This analysis assists in determining causes of congestion, such as an unexpected influx of high-bandwidth users in a specific area, and in identifying proactive solutions to mitigate such congestion. The intelligent controller can send recommendations to the RAN or to a third-party RIC to influence the RAN behavior for those users, adjusting parameters like beamforming patterns, scheduling priorities, and handover decisions.

For instance, in response to detected congestion, the network can determine optimal adjustments to the communications provided by each of the multiple microcells to improve QoS. Adjustments may include dynamically configuring microcells to perform beam pointing and beam shaping to direct radio signals toward areas with higher user density, thereby enhancing signal strength and reducing interference. Traffic shaping techniques can be applied to prioritize network resources for users with higher QoS requirements as defined in their SLAs.

Consider an example scenario in a shopping mall environment depicted in FIG. 1, where multiple microcells 120 provide cellular network coverage. Suppose a department store within the mall aims to ensure that its customers maintain a high QoS as they approach and move within the store. As customers carrying UEs approach the store from any direction, the AI/ML models hosted on the microcells recognize the pattern of increasing user density. The RIC leverages this information to dynamically configure one or more microcells to adjust their beamforming parameters, focusing signal strength toward these users to maintain high QoS and mitigate interference.

For example, multiple cellular microcells 120 are strategically installed throughout the mall to provide comprehensive cellular network coverage. Each microcell, such as microcell 120-1, includes a processing system 122-1 that hosts both the Distributed Unit (DU) 124-1 and the Radio Access Network (RAN) Intelligent Controller (RIC) 123-1. The DU manages local control of the microcell's Radio Units (RUs), including scheduling communications with User Equipment (UE). The RIC hosts advanced AI/ML models trained to recognize patterns of user behavior and network conditions within the environment.

As customers carrying UEs approach the department store from any direction, their devices are consistently tracked across the network using a Unified Network Identifier (UNI), which combines standardized identifiers like the International Mobile Subscriber Identity (IMSI) and the Subscription Permanent Identifier (SUPI). This consistent identification allows for accurate aggregation of data on user density and movement patterns. The AI/ML models running on the RICs analyze real-time data from the microcells to detect patterns of increasing user density near the department store. These models consider factors such as time of day, day of the week, and historical data indicating that, for example, the store experiences higher foot traffic during certain hours. By learning from these patterns, the models can predict impending congestion before it occurs.

Upon recognizing the surge in user density, the RIC leverages this information to dynamically adjust the network configuration. Specifically, it sends instructions to the DU to modify the beamforming parameters of the microcells' RUs. Beamforming involves adjusting the amplitude and phase of the signals transmitted by the antenna elements to direct the radio energy toward a specific area where increased user density is detected.

For instance, microcell 120-2 and microcell 120-3, which are in proximity to the department store, can be configured to steer their beams towards the store's entrance and interior spaces. This targeted beamforming enhances signal strength and quality for the customers within the store, ensuring they experience high Quality of Service (QoS) as they move around. It also helps in mitigating interference by reducing signal overlap with adjacent areas where high coverage is not required at that moment.

Additionally, the RIC may coordinate beamforming adjustments among multiple microcells to manage the overall network performance. For example, if microcell 120-3 is experiencing high load due to the increased number of UEs, the RIC might direct some UEs to be served by neighboring microcell 120-2 by adjusting their respective beam patterns and scheduling priorities. This dynamic load balancing ensures that no single microcell becomes a bottleneck, maintaining optimal network performance.

In another scenario, the department store utilizes various devices such as point-of-sale payment systems requiring low latency and high reliability, tablets carried by salespeople necessitating moderate bandwidth, and customers' smartphones with varying QoS needs. The microcells can be dynamically configured to provide the most appropriate QoS for each category of user by adjusting scheduling priorities and resource allocation based on their SLAs. For example, the RIC may instruct the DU to prioritize uplink and downlink resources for payment systems to ensure transaction reliability, while allocating sufficient resources to sales tablets and managing the remaining capacity for customer smartphones.

For example, each microcell in the store, such as microcell 120-3, is equipped with a processing system hosting the DU 124-3 and the RIC 123-3. The devices are identified and tracked using the Unified Network Identifier (UNI), allowing consistent recognition across the network and enabling per-device or per-category QoS management. The RIC utilizes AI/ML models to analyze network usage patterns and the specific requirements of each device category. It monitors factors such as the number of active devices, their data transmission rates, and the QoS parameters specified in their SLAs.

For instance, the POS systems might be identified as high-priority devices due to their critical role in business operations. Based on this analysis, the RIC dynamically adjusts scheduling priorities and resource allocations within the DU. For the POS systems, the RIC instructs the DU to prioritize uplink and downlink resources to guarantee low latency and high reliability. This may involve reserving specific time slots or frequency resources exclusively for POS communications, ensuring that payment transactions are processed without delay. For the salespeople's tablets, the RIC allocates sufficient bandwidth to support applications like inventory management and customer engagement tools. While these devices do not require as stringent latency requirements as the POS systems, they still need reliable connectivity. The RIC balances their resource allocations to maintain their operational effectiveness without impeding the higher-priority POS systems. Customers' smartphones present a diverse set of QoS needs, ranging from simple messaging to high-definition video streaming. The RIC manages the remaining network capacity to accommodate these varying demands. It may implement traffic shaping policies that optimize bandwidth usage, such as limiting the maximum throughput for non-critical applications during peak usage times to ensure fair distribution of resources.

Furthermore, the RIC can utilize beamforming techniques to enhance connectivity for devices based on their locations and priorities. For example, if a cluster of customers is congregating in a specific area of the store, the microcells can adjust their beam patterns to improve signal quality in that zone. Conversely, resources can be shifted away from areas with low device activity to maximize overall network efficiency. The AI/ML models continuously learn and adapt to changes in device usage patterns and network conditions. They can predict busy periods, such as sales events or holidays, and preemptively adjust network configurations to handle the anticipated increase in device activity. This proactive approach ensures that all device categories receive the appropriate QoS as defined in their SLAs, enhancing user experience and operational efficiency.

Another example scenario can occur in a modern hospital, where reliable and prioritized communication is crucial for patient care and operational efficiency. Multiple microcells, such as microcells 120 in FIG. 1, are deployed throughout the hospital to provide comprehensive cellular network coverage. Each microcell includes a processing system hosting a DU and a RIC. The hospital environment involves various categories of devices: critical medical equipment like patient monitors requiring ultra-low latency and high reliability, doctors' tablets needing secure and responsive access to patient records, and visitors' smartphones with standard connectivity needs.

Using UNIs, each device is consistently identified across the network, allowing for precise tracking and QoS management. The AI/ML models running on the RICs analyze real-time network data and device requirements. For critical medical equipment, the RIC assigns the highest priority, instructing the DU to allocate dedicated resources and prioritize uplink and downlink scheduling to ensure continuous, uninterrupted data transmission. Beamforming techniques are utilized to enhance signal strength specifically in areas with critical equipment, such as intensive care units, by adjusting the amplitude and phase of signals transmitted by the antenna elements. Doctors' tablets are assigned a high priority with secure communication channels. The RIC configures the microcells to provide encrypted connections and sufficient bandwidth for accessing large medical imaging files and patient records. Traffic shaping policies are applied to guarantee that these devices maintain the necessary QoS without being affected by network congestion. For visitors' smartphones, which require standard connectivity, the RIC manages the remaining network capacity, ensuring that critical medical devices and staff equipment are not impacted by visitor usage.

The AI/ML models continuously learn from the network's performance and adapt to changing conditions, such as increased visitor numbers during visiting hours or sudden surges in data from medical devices in emergency situations. By proactively adjusting network configurations, the system maintains the QoS as defined in the SLAs for each device category, ensuring patient safety and efficient hospital operations.

Another example scenario can occur in an advanced manufacturing facility, where multiple microcells are installed to provide robust cellular network coverage essential for the operation of autonomous robots, industrial sensors, and communication devices used by maintenance staff. The autonomous robots require real-time communication with control systems, demanding ultra-low latency and high reliability to function correctly and safely. Industrial sensors distributed across the factory floor need consistent connectivity to transmit data for monitoring equipment status and production metrics. Maintenance staff use handheld devices and tablets requiring moderate bandwidth and reliable connectivity.

Each device is assigned a UNI for consistent tracking and QoS management across the network. The AI/ML models in the RICs analyze device requirements and network conditions, prioritizing resources accordingly. For autonomous robots, the RIC instructs the DUs to allocate priority resources, ensuring minimal latency and high data throughput. Beamforming is employed to direct strong signals toward the robots' operating zones, enhancing communication reliability and reducing the risk of interruptions. Industrial sensors are given priority for reliable data transmission but with less stringent latency requirements. The RIC configures the microcells to provide sufficient bandwidth and stable connections for these sensors, applying traffic shaping where necessary to prevent data bottlenecks. Maintenance staff devices are allocated resources that ensure they have the connectivity needed to perform diagnostics, access manuals, and communicate with other staff without impeding the critical operations of robots and sensors.

The AI/ML models predict shifts in network demand based on production schedules and historical data. For example, during peak production times, when robot activity is highest, the system preemptively adjusts network configurations to accommodate increased data flow. In the event of a network anomaly or unexpected surge in data traffic, the AI/ML models detect the issue and dynamically reallocate resources or adjust beamforming parameters to maintain QoS for critical devices. This ensures the factory operates smoothly, with minimal downtime and optimal efficiency.

Another scenario can occur in a large outdoor music festival, where multiple microcells are deployed to cover the expansive area, providing network connectivity for attendees, performers, and event staff. The attendees primarily use their smartphones for messaging, social media, and streaming services. Performers and production crew require reliable, low-latency connections for live broadcasting, stage coordination, and control of lighting and special effects. Event security and emergency services need priority communication channels for safety operations.

Using UNIs, every user's device is consistently tracked across the network. The AI/ML models running on the RICs analyze crowd movement patterns, network usage, and device categories. For performers and production crew, the RIC prioritizes network resources by instructing the DUs to allocate dedicated channels with high bandwidth and low latency, essential for live broadcasts and coordinated stage operations. Beamforming techniques are applied to strengthen signals at the main stage and production areas, ensuring uninterrupted connectivity.

For event security and emergency services, the RIC configures the microcells to provide secure and prioritized communication channels. This may involve reserving specific frequency bands exclusively for these services, employing encryption, and ensuring minimal interference. Traffic shaping policies are implemented to guarantee that these critical communications remain unaffected by the high network demand from attendees. Attendees' smartphones are managed by balancing network capacity and applying QoS policies that provide satisfactory service without compromising critical operations. The AI/ML models predict areas of high network congestion based on crowd density, such as near popular stages or food courts. The system dynamically adjusts beamforming patterns and resource allocations to mitigate potential bottlenecks, enhancing user experience.

Additionally, the AI/ML models can detect sudden changes in network patterns that may indicate emergencies, such as rapid shifts in user locations or spikes in communication from certain areas. In such cases, the system can adapt by reallocating resources to support emergency services and facilitate crowd safety measures. By intelligently managing the network based on user categories and real-time data, the system ensures a successful event with efficient communications for all stakeholders.

As described above, embodiments use AI/ML for pattern recognition and trend analysis. Implementing the AI/ML components for per-user and per-user-category features of the invention involves several reasonable options that leverage different AI/ML architectures and methodologies to enhance network performance and QoS management. Some implementations utilize centralized AI/ML models hosted on the RICs within the microcells. These models analyze aggregated data from all connected UEs, using the UNI to consistently track users across the network. The centralized models can employ supervised learning algorithms, trained on historical network data tagged with performance metrics and corresponding network configurations. This training enables the models to predict optimal network adjustments for varying user patterns and behaviors.

Some implementations use distributed AI/ML models at the microcell level, where each microcell hosts its own AI/ML instance within its processing system. These models focus on local network conditions, analyzing data specific to their coverage area. By using unsupervised learning techniques, such as clustering algorithms, the models can identify patterns and anomalies in user behavior without predefined labels. This approach allows microcells to autonomously adjust parameters like beamforming and scheduling priorities in response to real-time conditions, enhancing QoS for individual users and user groups.

Some implementations use reinforcement learning for the AI/ML. Models learn optimal network configurations through trial and error, receiving feedback in the form of rewards based on achieved QoS levels and network efficiency. Over time, the reinforcement learning models converge toward strategies that maximize overall network performance while adhering to the SLA requirements of different user categories. Such implementations are particularly effective in dynamic environments where user behavior is unpredictable.

Some implementations use federated learning to address privacy concerns associated with centralized data processing. AI/ML models are trained locally at each microcell using local data, and only the model updates are shared with a central server or other microcells. This allows the network to benefit from collective learning across multiple microcells without transmitting sensitive user data, maintaining compliance with privacy regulations.

For per-user QoS adaptation, AI/ML models can analyze individual user profiles, usage patterns, and SLA specifications to tailor network resources accordingly. Techniques like decision trees and support vector machines can be used to classify users into different priority levels, enabling the network to allocate resources in a way that meets individual QoS requirements. By continuously monitoring user behavior, the models can adjust allocations in real time, ensuring that high-priority users receive the necessary bandwidth and low latency.

Embodiments can use predictive analytics, where AI/ML models utilize time series forecasting methods to anticipate network congestion and user demand patterns. By predicting potential hotspots and periods of high usage, the network can proactively adjust configurations, such as preemptively reallocating resources or adjusting beamforming directions. This helps in maintaining QoS during peak times and prevents degradation of service.

Additionally, AI/ML can be implemented to optimize beamforming and resource allocation by using deep learning models, such as neural networks, that learn complex patterns in the data. These models can process high-dimensional inputs, including user location, signal strengths, and interference levels, to calculate the optimal beamforming vectors and resource block assignments. This results in improved signal quality and efficient use of the network spectrum.

Some implementations integrate AI/ML models with policy control functions within the network core, such as the Policy Control Function (PCF). By doing so, the AI/ML models can make decisions that are aligned with the network's policies and regulatory requirements. The models can recommend policy updates or exceptions in real time to accommodate unique situations, such as emergency services requiring immediate high-priority access.

Some embodiments combine multiple AI/ML techniques. For example, using a hybrid model that incorporates both supervised and unsupervised learning allows the network to benefit from predefined knowledge while still discovering new patterns in user behavior.

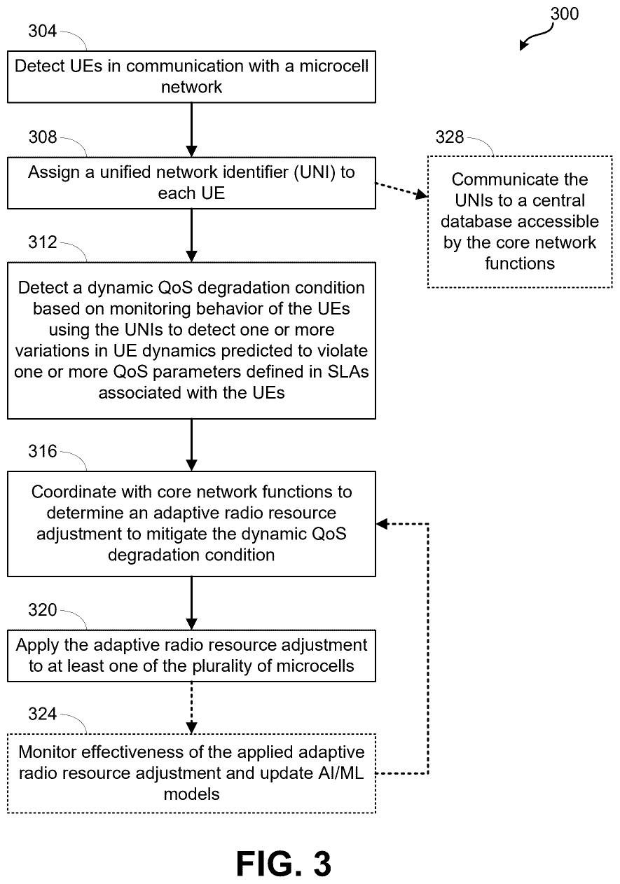

FIG. 3 shows a flow diagram of a method 300 for managing quality of service (QoS) in a microcell network comprising a plurality of collocated microcells, according to some embodiments described herein. Embodiments begin at stage 304 by detecting a plurality of user equipment (UEs) in communication with the microcell network. This detection can be performed by the microcells themselves using their distributed units (DUs), by Radio Access Network (RAN) Intelligent Controllers (RICs) hosted within the microcells, or in any other suitable manner. The detection can involve monitoring active UE connections, signal strengths, communication protocols such as 5G New Radio (NR), and other parameters such as UE density within a specific region or microcell. The DUs within the microcells can track the number of UEs communicating with each microcell, while the RICs can aggregate this data to form a comprehensive view of the network state.

In stage 308, embodiments can assign a unified network identifier (UNI) to each of the plurality of UEs. The UNI can be generated using a variety of methods, such as deriving it from standardized identifiers like the International Mobile Subscriber Identity (IMSI) or the Subscription Permanent Identifier (SUPI). For enhanced privacy, the UNI may instead be based on a Subscription Concealed Identifier (SUCI) generated using encryption techniques. Alternatively, the UNI may be assigned as a Globally Unique Temporary Identifier (GUTI) synchronized across the microcell network, or it may be generated using a hashing mechanism applied to permanent identifiers. Once assigned, the UNIs allow consistent tracking of UEs across the network, enabling seamless coordination and data correlation between microcells, DUs, and core network functions.

In stage 312, embodiments can detect a dynamic QoS degradation condition by monitoring the behavior of the plurality of UEs using the assigned UNIs. As used herein, dynamic QoS degradation refers to real-time changes in network conditions, such as increased UE density, unexpected data surges, or environmental factors, that result in a deviation from SLA-defined QoS parameters. These conditions can be detected using AI/ML models analyzing metrics like SINR, throughput, and latency. The detection at stage 312 can involve analyzing real-time data to identify one or more variations in UE dynamics, such as changes in UE density, movement patterns, or data usage, that are predicted to violate QoS parameters defined in service level agreements (SLAs) associated with the UEs. AI/ML models hosted on the RICs play a key role in this detection process, leveraging supervised or unsupervised learning techniques to recognize patterns or anomalies in network conditions. For example, the models may identify a surge in UE density near a specific microcell, signaling potential congestion and impending QoS degradation. The detection process can operate at both individual UE levels and UE category levels, allowing for granular analysis of network behavior.

In stage 316, embodiments can coordinate with core network functions to determine an adaptive radio resource adjustment to mitigate the detected dynamic QoS degradation condition. This coordination involves communication between the RICs and core network components such as the Network Repository Function (NRF), Network Slice Selection Function (NSSF), Policy Control Function (PCF), and Access and Mobility Management Function (AMF). For instance, the NSSF may assist in reallocating UEs to different network slices to balance the load, while the PCF can define updated QoS policies to prioritize critical UEs or UE categories. The RICs may also request additional network resources or adjustments to scheduling priorities to address the specific conditions causing the QoS degradation.

In stage 320, embodiments can apply the adaptive radio resource adjustment to at least one of the plurality of microcells. This adjustment may involve a combination of techniques such as modifying beamforming or beam steering parameters to direct radio frequency energy toward areas of higher UE density, adjusting transmission power levels to expand or shrink the coverage area of specific microcells, or reallocating communication slots and frequency blocks to prioritize UEs with higher QoS requirements as defined in their SLAs. For example, a microcell experiencing high traffic may dynamically adjust its beamforming to offload UEs to neighboring microcells or prioritize critical UEs by providing them with a greater share of available bandwidth. In some implementations, when applying adaptive radio resource adjustments, the microcells dynamically reallocate bandwidth, adjust physical resource blocks, and/or prioritize slices for UEs with critical QoS requirements. These adjustments can be informed by real-time data collected by the distributed units (DUs) and analyzed by AI/ML models hosted on one or more RICs.

In some embodiments, the method 300 can continue, in stage 324, by utilizing AI/ML models (e.g., the AI/ML models hosted on the RICs) to monitor the effectiveness of the applied adaptive radio resource adjustment. In some implementations, the AI/ML models are trained using supervised and unsupervised learning techniques. Data inputs can include historical UE density, movement patterns, SLA compliance metrics, etc. The models can be deployed in real-time to detect anomalies and predict QoS degradation conditions, enabling proactive resource adjustments.

For example, the RICs collect post-adjustment data, including updated network performance metrics and QoS compliance rates, to determine whether the applied changes successfully mitigated the dynamic QoS degradation condition. The AI/ML models can compare this data against historical patterns to refine their predictive capabilities and identify areas for further improvement. Further in stage 324, such embodiments can update the AI/ML models based on the effectiveness of the applied adaptive radio resource adjustment. This updating process may involve retraining the models using new data collected from the network, enabling them to adapt to changing conditions and improve their accuracy over time. For example, if certain beamforming adjustments consistently yield better results in specific scenarios, the models can incorporate this knowledge to make more informed decisions in the future.

In some embodiments, in stage 328, the method 300 can communicate the assigned UNIs to a central database accessible by the core network functions. This centralized repository ensures that all components of the network, including the microcells, DUs, RICs, and core network functions, can access consistent and accurate information about the UEs. The UNIs facilitate seamless coordination between network components, enabling advanced QoS management techniques such as predictive resource allocation and intelligent congestion mitigation.

### Beam Steering Based on Predictive User Location

In another set of embodiments, beam steering is performed on a per-antenna basis based on predictive user location, utilizing AI/ML models to anticipate user movements within an indoor environment. Such environments may include shopping malls, factories, hospitals, convention centers, and similar settings where user equipment (UE) movement patterns tend to follow predictable paths. By leveraging predictive analytics, the RICs hosted on microcells can dynamically adjust the directionality of individual antenna beams to optimize coverage and QoS. This approach helps to ensure that the network provides seamless connectivity while minimizing interference and maximizing resource efficiency.

The term “microcell energy distribution field (MEDF)” is used herein to describe a field formed by the combined radiation patterns of the plurality of microcells (i.e., by the combinations of their antenna radiation patterns), which represents the spatial distribution of radio frequency (RF) energy across the environment. As described herein, the MEDF is dynamically shaped by the microcell network through adjustments to beamforming and/or beam steering. This can enable the system to optimize network performance, balance load, and/or ensure adequate coverage in high-demand areas.

For example, AI/ML models hosted on the RICs analyze real-time network data, such as signal strength, signal-to-noise ratio, and the current microcell antenna serving the UE. By correlating this information with historical movement patterns and environmental layout data (e.g., floor plans of a mall or factory), the AI/ML models can predict the likely movement path of UEs. For instance, in a shopping mall, a UE located near an escalator may be predicted to move toward a specific floor or store section based on historical trends, time of day, time-of-day patterns, and/or signal quality metrics. Similarly, in a factory, a UE mounted on an autonomous robot may follow a predefined route based on production schedules.

Once the AI/ML model predicts the movement of UEs, the RIC directs the RAN to dynamically adjust the beamforming configuration of one or more antennas. For example, the signal from a specific antenna may be steered in the predicted direction of the UE's movement for a defined duration of time, ensuring that the UE consistently receives high-quality connectivity as it moves. This predictive beam steering provides a proactive approach to managing UE mobility, avoiding disruptions in service that might otherwise occur during handoffs between microcells or antennas. Moreover, beam steering can be performed at the level of individual antennas within a microcell, allowing for fine-grained control over the coverage area and signal strength.

Embodiments can predict spatial UE capacity demand by analyzing a combination of real-time and historical data, including metrics such as UE density, signal quality, bandwidth usage, and application-specific requirements. For example, the AI/ML models hosted on the RICs process these inputs to generate spatial predictions, accounting for recurring patterns such as time-of-day traffic surges or event-driven UE density increases. In some implementations, the AI/ML models hosted on the RICs are trained to predict spatial UE capacity demand by analyzing diverse inputs, such as real-time signal quality metrics, historical UE activity patterns, and contextual environmental data. These models can leverage supervised and/or unsupervised learning techniques to identify patterns, adapt to changing conditions, and refine their predictions over time.

In certain embodiments, the RIC may coordinate beam steering among multiple microcells to ensure a seamless user experience. For example, if a UE is predicted to move from the coverage area of microcell 120-2 to that of microcell 120-3, the RIC can direct microcell 120-2 to steer its antenna beam toward the UE's expected location until it enters the coverage area of microcell 120-3. Concurrently, microcell 120-3 may preemptively steer its antenna beam to the UE's predicted entry point, ensuring a smooth transition between microcells. This coordinated beam steering reduces the likelihood of dropped connections or degraded service during the transition.

In addition to improving connectivity for individual UEs, predictive per-antenna beam steering can enhance overall network efficiency. By directing signal energy only where it is needed, the network minimizes interference with other UEs and microcells, enabling more efficient use of spectrum and power resources. For example, if a large number of UEs are predicted to move toward a specific area, such as a food court in a shopping mall, multiple antennas can be dynamically steered to concentrate coverage in that area while reducing coverage in less congested regions. This dynamic reallocation of resources ensures that QoS requirements for all UEs are met, even during periods of high demand.

The AI/ML models used for predictive beam steering are trained using supervised or unsupervised learning techniques, leveraging data collected from past UE movements and environmental conditions. For example, the models may analyze historical signal quality data, time-stamped UE locations, and patterns of user density to identify recurring trends. Over time, the models continuously adapt to new data, improving their ability to predict user movements in dynamic environments. In some embodiments, reinforcement learning techniques are employed, allowing the models to refine their predictions based on the success or failure of previous beam steering actions.

As an example, consider a scenario in a hospital where staff members carrying tablets frequently move between patient rooms and a central nurse's station. The AI/ML models predict these movement patterns based on real-time and historical data, directing individual antennas within microcells to steer their beams toward the predicted locations of the tablets. This ensures that staff members maintain uninterrupted access to critical patient information as they move through the hospital. Similarly, in a manufacturing facility, antennas may dynamically adjust their beams to maintain low-latency connectivity with autonomous robots as they navigate the factory floor.

In another example, during a large event in a convention center, the AI/ML models may predict that attendees will move toward specific exhibit halls or breakout rooms at scheduled times. The RIC can direct individual antennas to steer their beams toward these areas in anticipation of increased user density, ensuring that attendees experience optimal connectivity even as they move through the venue. As users leave an area, the antennas can dynamically adjust their beams to follow the next predicted user movement, maintaining efficient coverage throughout the event.

By implementing predictive per-antenna beam steering, the network can anticipate and adapt to user movements in real time, providing superior QoS while optimizing resource utilization. This approach complements other techniques described herein, such as load balancing, coordinated multipoint (COMP), and traffic shaping, to deliver a robust and intelligent network capable of meeting the demands of modern environments.

In some embodiments, beam steering across multiple microcells is coordinated through a hierarchical communication protocol between the RICs and the Distributed Units (DUs). Such coordination can include: data sharing by which microcells share real-time data on user density, signal quality, and bandwidth usage with the RIC; handoff prediction by which the RIC uses AI/ML models to predict when UEs will move from one microcell's coverage area to another and preemptively adjusts beamforming and resource allocations to ensure seamless transitions; and load balancing by which if one microcell becomes overloaded, neighboring microcells dynamically adjust their beams to offload UEs while maintaining QoS compliance. For instance, in a stadium, if a surge of users moves toward a specific seating section, the RIC coordinates with multiple microcells to dynamically redistribute coverage and resources, ensuring uninterrupted connectivity.

In some embodiments, the RICs coordinate beamforming and beam steering adjustments across multiple microcells to achieve collective shaping of the MEDF. This coordination ensures seamless transitions for UEs moving between microcell coverage areas and optimizes resource allocation by dynamically redistributing radio frequency energy to high-demand regions. In some embodiments, dynamic reallocation of radio frequency energy can be achieved by modifying the MEDF in response to real-time network conditions. This involves adjusting the amplitude and phase of antenna signals within individual microcells to redistribute energy toward areas of high UE density or critical QoS requirements, thereby improving overall network efficiency. Some implementations include hierarchical coordination architectures, in which RICs can leverage shared data from neighboring microcells to dynamically adjust beam steering configurations. For example, if a surge in UEs is detected at the boundary of two microcells, their respective beam patterns can be collaboratively refined to distribute the load and maintain seamless coverage.

In some alternative embodiments, the AI/ML models used for predictive per-antenna beam steering may incorporate additional contextual information beyond historical movement patterns to enhance their accuracy. For example, the RICs may be programmed with knowledge of specific events or scheduled activities within the environment. In a shopping mall, the AI/ML models may factor in store operating hours or scheduled promotional events that are likely to draw increased foot traffic to certain areas. Similarly, in a hospital, the models may integrate staff schedules, visiting hours, or even patient transfer routines to predict where high-priority devices, such as medical tablets or portable monitors, are likely to move. By incorporating such contextual information, the predictive capabilities of the AI/ML models can be significantly enhanced, allowing for more proactive and precise beam steering to ensure uninterrupted connectivity.

In other embodiments, the predictions made by the AI/ML models may prioritize factors beyond user movement patterns when determining optimal beam steering configurations. For instance, predictions may account for changes in bandwidth demand in specific locations or shifts in the types of applications being used by UEs. For example, in an indoor event venue, the AI/ML models may detect that a group of UEs in one area is primarily engaging in bandwidth-intensive activities, such as live video streaming, while UEs in another area are using applications with lower bandwidth requirements, such as messaging or email. Even if a larger number of UEs are concentrated in the second area, the RICs may direct beam steering to prioritize the bandwidth-hungry group to ensure their QoS requirements are met.

In some embodiments, AI/ML models used for predictive beam steering are trained on a combination of real-time and historical data sources to ensure accurate and adaptive performance. Training data can include, but is not limited to, the following: signal quality metrics, such as signal-to-interference-plus-noise ratio (SINR), received signal strength indicator (RSSI), channel quality indicator (CQI), and bit error rate (BER), collected continuously from UEs; environmental data, such as floor plans, UE density maps, historical heatmaps of user activity, and time-stamped user movement patterns across different environments (e.g., shopping malls, hospitals, factories); network performance metrics, such as bandwidth usage, latency, jitter, and packet error rates for various applications and QoS levels; real-time updates, such as continuous updates from active UEs, including their location, device type, and current application bandwidth requirements; and/or user feedback and anomalies, such as data collected from user feedback on QoS and detected anomalies (e.g., unexpected congestion or signal degradation). The training process can employ supervised learning techniques to map input data (e.g., signal quality, user density, and movement patterns) to desired outcomes (e.g., optimal beamforming configurations). Additionally, unsupervised learning methods can be used to detect anomalies or emerging patterns in network usage.

Predictive beam steering can also be performed based on anticipated load balancing needs and other dynamic conditions, utilizing AI/ML models to analyze real-time and historical data on user density, data usage patterns, and application-specific bandwidth requirements. In addition to predicting user movement paths, the AI/ML models hosted on the RICs can dynamically assess network load conditions across multiple microcells and individual antennas within a microcell. These models can consider factors such as current and projected UE density, communication patterns, QoS requirements, and/or specific application demands to determine optimal resource allocation strategies.

For example, in a shopping mall environment, the AI/ML models may predict a surge in user density near a food court during lunchtime based on historical data and time-of-day patterns. In response, the RICs may direct the microcells to preemptively adjust their beamforming configurations to redistribute load among neighboring microcells. This adjustment may involve dynamically steering antenna beams to expand the coverage area of less-loaded microcells while narrowing the coverage of more heavily loaded microcells, effectively reducing congestion and maintaining QoS compliance for all UEs.

Additionally, predictive load balancing may involve coordinating resource allocation across multiple microcells. For instance, if a high-density UE area is detected near the overlap of two microcell coverage areas, the RICs may instruct one microcell to prioritize service to UEs with high QoS requirements while directing the other microcell to handle lower-priority UEs. By dynamically optimizing beamforming and load balancing in tandem, the system ensures efficient utilization of network resources and superior service quality for all users.

In certain embodiments, predictive load balancing may be integrated with application-specific resource allocation. For example, in a factory environment, the AI/ML models may predict that autonomous robots operating in a specific zone will require increased bandwidth during a scheduled production cycle. The RICs may preemptively direct antennas to steer their beams toward the anticipated locations of the robots while reallocating resources from less critical UEs or idle zones. This approach ensures that critical devices maintain uninterrupted connectivity and performance during peak operational periods.

To further enhance predictive capabilities, the AI/ML models may incorporate additional contextual data, such as event schedules, production timelines, or user activity patterns. For instance, in a hospital environment, the system may predict increased demand in patient rooms during visiting hours and dynamically adjust beam steering and load balancing configurations to accommodate the surge in UEs. Similarly, during an outdoor event such as a music festival, the RICs may predict high bandwidth demand near the main stage during performance times and preemptively direct multiple antennas to concentrate coverage in that area.

Similarly, in a factory environment, the AI/ML models may detect that a high-bandwidth autonomous robot is moving along a predefined route while other UEs, such as handheld devices used by workers, are stationary or engaged in low-bandwidth activities. In such scenarios, the beam steering algorithms may prioritize the robot's predictable path to maintain low latency and high data throughput, even if the number of UEs in other areas is greater. This approach ensures that the network intelligently allocates resources to high-priority devices and applications while still maintaining adequate service for all other UEs.

By combining predictions of user movement patterns with additional factors such as bandwidth demand, application type, or contextual knowledge of the environment, embodiments can provide a holistic and adaptive method for managing beam steering. This flexibility ensures that the network can dynamically optimize both connectivity and resource allocation to meet the diverse and evolving needs of users and applications, further enhancing the robustness of the overall system.

Beam steering algorithms can dynamically adjust the amplitude and phase of signals transmitted by individual antenna elements to direct radio frequency energy toward specific regions. Embodiments of such beam steering algorithms can include: input data analysis, such as by feeding real-time data on UE location, SINR, and/or historical movement patterns into the AI/ML models hosted on the RICs; phase and amplitude adjustment, such as by the RIC computing the optimal phase shift and amplitude for each antenna element using mathematical models such as Fourier transform-based or minimum mean square error (MMSE) beamforming algorithms; beam pattern formation, such as by the antennas forming beams, using computed parameters, with specific shapes and directions to focus signal energy on high-density UE regions or predicted movement paths; and dynamic tuning, such as by continuously updating parameters based on real-time feedback, and compensating for multi-path fading, interference, and environmental reflections, particularly in enclosed indoor environments. For example, in a factory environment, if autonomous robots move through areas with high signal reflection, the system compensates by adjusting the beam patterns to maximize signal strength in the desired direction while minimizing interference.

In general, beamforming can be implemented through precise phase and amplitude adjustments for individual antenna elements within a microcell. These adjustments can be calculated using advanced algorithms, such as minimum mean square error (MMSE) beamforming, to direct RF energy toward specific regions of the environment while minimizing interference and optimizing spectral efficiency.

Embodiments can be designed to handle edge cases and dynamic conditions that may disrupt normal network operations. One type of such cases involves sudden surges in user density. For example, if a large number of UEs suddenly congregate in a specific area (e.g., during a flash sale in a shopping mall), embodiments can dynamically redistribute load by directing additional antennas to cover the affected region or handing off UEs to neighboring microcells. Another type of such cases involves equipment malfunctions. For example, if an antenna or microcell experiences a hardware failure, the RIC initiates fallback mechanisms, such as reverting to omnidirectional transmission or redistributing affected UEs to functioning antennas or microcells. Another type of such cases involves environmental changes. For example, for temporary obstructions (e.g., construction zones in a factory), the system adjusts beamforming parameters to minimize signal degradation and ensure consistent QoS. Fallback mechanisms can be implemented to ensure service continuity. For instance, in the event of severe congestion, the system prioritizes high-QoS users by reallocating bandwidth and scheduling resources while maintaining baseline service for lower-priority users.

Some embodiments implement predictive beam steering with strict real-time constraints to ensure low-latency communication. Some such embodiments incorporate edge computing techniques. For example, RICs perform real-time AI/ML model execution at the network edge, reducing latency associated with centralized processing. Other such embodiments incorporate hardware acceleration. For example, beamforming computations leverage hardware accelerators, such as field-programmable gate arrays (FPGAs) or graphics processing units (GPUs), to speed up calculations. Other such embodiments incorporate latency management techniques. For example, embodiments ensure that beamforming adjustments occur within milliseconds, meeting the latency requirements for applications such as autonomous robotics and real-time video streaming.

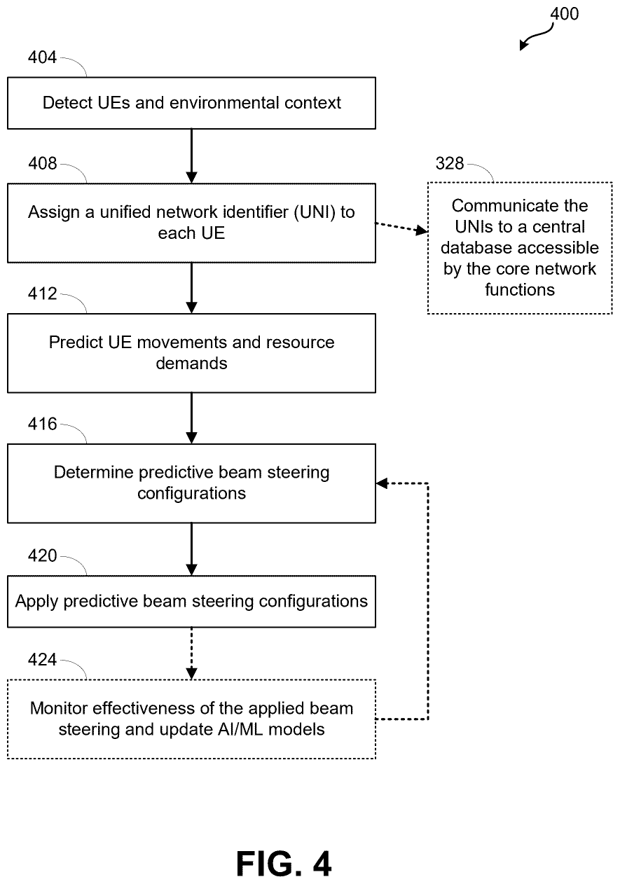

FIG. 4 shows a flow diagram of an illustrative method 400 for predictive per-antenna beam steering in a microcell network, according to some embodiments described herein. Embodiments begin at stage 404 by detecting UEs in communication with the microcell network and gathering contextual environmental data. This detection can involve monitoring active UE connections, signal quality metrics (e.g., signal-to-noise ratio, received signal strength), and movement patterns. Additionally, the system may collect contextual information, such as environmental schedules (e.g., store hours, staff shifts, visiting hours, or event schedules) and historical data about high-demand areas or periods. This data is obtained using the Distributed Units (DUs) within the microcells, Radio Access Network (RAN) Intelligent Controllers (RICs), or other network components capable of collecting and processing real-time and historical information.

In stage 408, embodiments assign a Unified Network Identifier (UNI) to each detected UE to enable consistent tracking across the network. As described in method 300, the UNI may be generated using identifiers such as the Subscription Permanent Identifier (SUPI), a Subscription Concealed Identifier (SUCI), or a hashed composite identifier derived from multiple UE attributes. The UNI allows the network to correlate movement patterns, usage behaviors, and QoS requirements across different nodes, enabling seamless coordination for predictive beam steering and resource allocation.

Embodiments can use various techniques to help protect user privacy during predictive beam steering. One such technique is anonymization of data. For example, user location data and identifiers, such as the UNI, are anonymized before being processed by the AI/ML models. Another such technique is data encryption. For example, all communication between microcells, RICs, and core network functions is encrypted using industry-standard protocols (e.g., TLS or IPsec). Another such technique is access control. For example, only authorized network components have access to sensitive user data, and access is logged for auditing purposes. Another such technique is to use privacy-preserving identifiers. For example, the UNI is generated using methods like the Subscription Concealed Identifier (SUCI), ensuring that permanent identifiers (e.g., IMSI) are not exposed.

In stage 412, embodiments utilize AI/ML models (e.g., hosted on the RICs) to predict the likely movement paths of UEs and assess anticipated resource demands. The models analyze real-time data, such as signal strength, UE location, and antenna association, in conjunction with historical movement patterns. Some implementations further account for contextual data (e.g., store hours, schedules, or high-demand event timings). For example, the AI/ML models may predict that a UE located near an escalator in a shopping mall will move toward a specific floor or store, or that an autonomous robot in a factory will follow its predefined route. Additionally, the models may prioritize predictions based on bandwidth-intensive applications or QoS requirements, such as live video streaming or low-latency communication for critical devices.

In stage 416, embodiments determine optimal per-antenna beam steering configurations based on the predictions generated in stage 412. In some implementations, this involves one or more RICs coordinating with one or more DUs. For example, antennas may be dynamically adjusted to steer beams toward the predicted future locations of UEs or high-demand areas. The configurations may also account for application-specific requirements, such as prioritizing bandwidth-hungry devices or ensuring low-latency connectivity for critical UEs. The RIC may further coordinate beam steering across multiple microcells to ensure seamless transitions for UEs moving between coverage areas.

In some embodiments, the determination in stage 416 includes integrating additional contextual and dynamic factors into the predictive beam steering process to enhance accuracy and resource efficiency. For example, the RICs may incorporate data on application types, bandwidth demand, or environmental schedules into their AI/ML models. This integration allows the system to prioritize high-bandwidth or critical applications, such as live video streaming or medical equipment communications, even if such priorities deviate from pure movement-based predictions. By continuously adapting to new data and environmental conditions, the network ensures optimal performance and resource utilization across all scenarios.

In stage 420, embodiments direct the microcells to apply the determined beam steering configurations to their antennas. For example, individual antennas may adjust the phase and amplitude of their signals to direct radio energy toward predicted high-density regions, anticipated UE locations, or areas with increasing bandwidth demand. Beam steering may be performed at the level of individual antennas within a microcell, allowing for fine-grained control over the coverage area and signal strength. This proactive adjustment ensures that UEs experience uninterrupted connectivity and that QoS requirements are met as they move through the environment. Some embodiments allocate additional RF energy to UEs with higher QoS requirements as defined in their SLAs. For example, UEs associated with critical applications, such as autonomous robots or medical devices, may receive prioritized beamforming adjustments or dedicated bandwidth to ensure uninterrupted service and compliance with their SLA parameters.

In some embodiments, the directing in stage 420 includes coordinating network-wide adjustments to maintain optimal QoS and resource allocation. For example, the RIC may direct multiple microcells to collaboratively adjust their beam steering configurations or reallocate resources to balance demand across the network. This coordination may involve shifting coverage areas, prioritizing specific UEs or applications, or dynamically reallocating bandwidth to high-demand regions. Such adjustments ensure that the network remains robust and responsive to dynamic conditions while meeting the diverse needs of users and applications.

Some embodiments, in stage 424, monitor the effectiveness of the applied predictive beam steering configurations. For example, real-time data, such as updated signal quality metrics, UE locations, and QoS compliance rates, is collected and analyzed to determine whether the adjustments successfully mitigated potential disruptions or met QoS requirements. The AI/ML models are updated based on this feedback to refine their predictive capabilities over time. For example, if a predicted movement pattern does not align with actual UE behavior, the models may adjust their algorithms to improve future predictions.

In some embodiments, real-time feedback from the network, including updated UE locations, signal quality metrics, and QoS compliance rates, is continuously monitored to assess the effectiveness of applied MEDF adjustments. Based on this feedback, the RICs dynamically refine beamforming and steering configurations, ensuring that the network adapts to evolving conditions and maintains optimal performance. For example, the AI/ML models hosted on the RICs are continuously updated using post-adjustment feedback, such as QoS compliance metrics, bandwidth usage, and user density data. This iterative retraining process helps to ensure that the models improve their ability to predict optimal MEDF configurations and adapt to evolving network conditions.

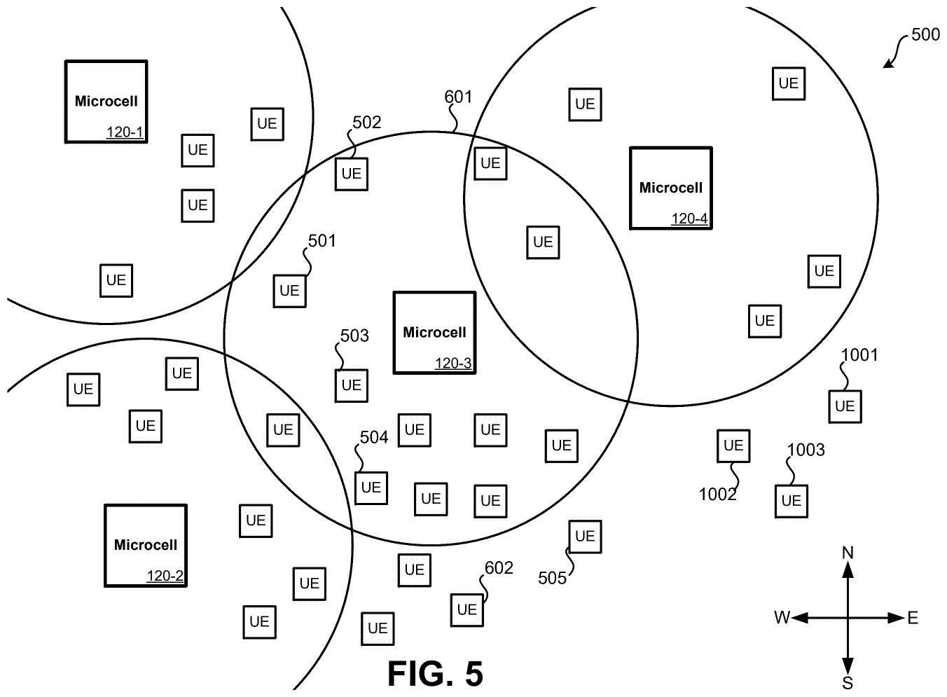

FIGS. 5-8 detail various arrangements in which multiple UE are communicating with multiple microcells. The described arrangements demonstrate features of different types of embodiments described above. FIG. 5 illustrates a block diagram of an embodiment 500 of multiple cellular microcells providing cellular service to multiple user equipment (UE) in an environment. In embodiment 500, cellular microcells 120 are arranged in an environment to provide cellular network access.

Various UE are present. In some embodiments, in order to access the cellular network through microcells 120, UE may be required to have access to a particular cellular network slice. Even if a UE has a subscription with the same cellular network provider that operates microcells 120, access to one of a particular group of authorized cellular network slices may be necessary. For example, an entity that operates a factory may have a designated slice that only its UE is permitted to use. In other embodiments, all UE permitted to access the cellular network may be permitted to access microcells 120. For example, microcells 120 may be located at a festival, stadium, or shopping mall and are intended to be used by UE operated by members of the public.

As shown in FIG. 5, various UE are present in an environment. In certain geographic regions, the UE are sparse, but in other regions, such as south of microcell 120-3, UE are more closely grouped. Where UE group may be influenced by the time of day and day of week. For instance, in the example of a shopping mall, UE may tend to be located in the food court around lunch time. As another example, UE may tend to congregate in a stadium around 1-4 PM on Sundays. Accordingly, the geographic regions where UE tend to congregate and place strain on the cellular network (e.g., by a large communication load being placed on particular microcells) may tend to repeat and be predictable.

In the example of FIG. 5, the large number of UE being serviced by microcell 120-3 may present a problem. Due to spectrum limitations and backhaul limitations, UE, such as UEs 501-504 may not receive optimal service. More specifically, UEs 501-504 may have been guaranteed particular QoS parameters in accordance with an SLA that may not be able to be met if all of the UE within range 601 are serviced by microcell 120-3.

In FIG. 5, UE may typically be provided service by the microcell with which the UE has the highest signal strength. For example, UE 503 (and other UE located within range 601) may be provided service by microcell 120-3.

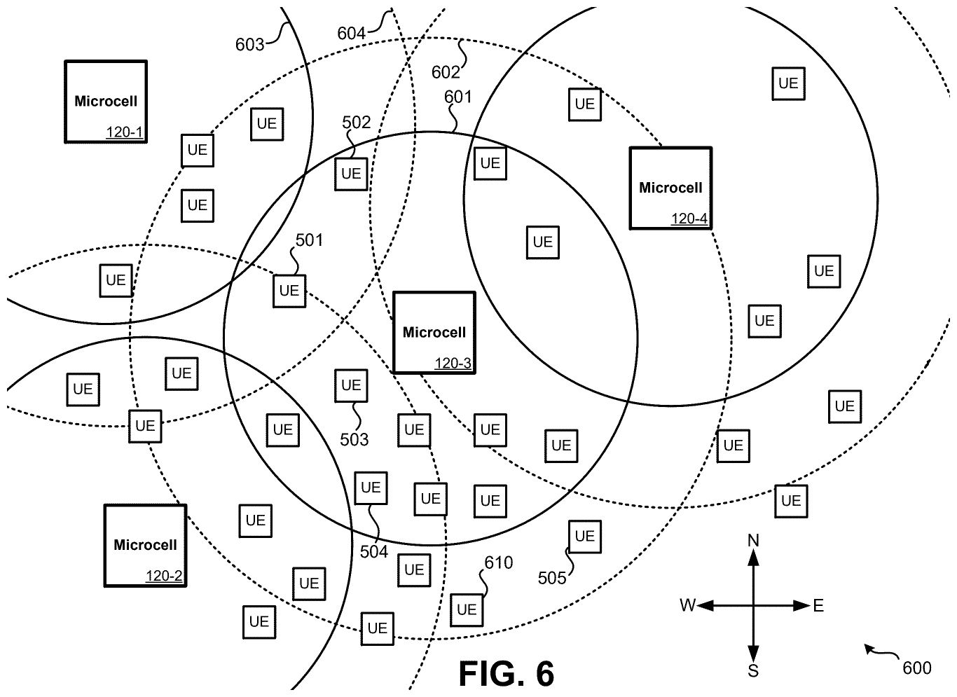

In order to improve on the performance provided by microcell 120 in embodiment 500, one or more RICs 123 (or RIC 155) may be used to preemptively (or reactively) alter the functionality of microcells 120 to perform load balancing. FIG. 6 illustrates a block diagram of an embodiment 600 of multiple cellular microcells providing cellular service to multiple UE in an environment using intelligent control and scheduling. In FIG. 6, while a particular microcell may provide a higher signal strength, one or more UEs may be serviced by another microcell with which communication is possible. Despite having a lower signal strength, handing off service to another microcell may improve service for the particular UE, for the group of UEs as a whole, or both.

Microcell 120-1 may have a high signal strength with UE within range 603. Within range 604, microcell 120-1 may still be able to communicate with UE, albeit possibly at a lower data transfer rate. UE 501, for example, may have a highest signal strength (e.g., strength of signal received from the microcell, or as measured by the microcell from the UE) with microcell 120-3 since UE 501 is within range 601. However, as previously detailed many UE are being serviced by microcell 120-3 and thus balancing the load of UE with other microcells in microcells 120 can improve performance.

Either in reaction to the load being detected by microcell 120-3 or in anticipation of the UE congregating south of microcell 120-3, a RIC (or multiple RICs operating in cooperation) may determine to shift a portion of the UE load from microcell 120-3 to other microcells. Referring to UE 501, UE 501 can be transferred to microcell 120-1. While the signal strength may be lower, the lower load in microcell 120-1 may allow for similar or improved service to be provided to UE 502. Further, by removing UE 501 from being served by microcell 120-3, communication bandwidth is freed at microcell 120-3 for use in communicating with other UE.

As another example, UE 503 and UE 504 can be transferred to microcell 120-2 from microcell 120-3. Again here, while the signal strength may be lower, the lower communication load of microcell 120-2 may allow for similar or improved service to be provided to UE 503 and UE 504. Further, by removing UE 503 and UE 504 from being served by microcell 120-3, communication bandwidth is freed at microcell 120-3 for use in communicating with other UE.

Other UE, such as UE 610 and UE 505, may only be able to communicate with microcell 120-3 (because they are within range 602 and not within range of any of microcell of microcells 120. Such UE may be prioritized and maintained on microcell 120-3 since no other microcell is available.

The RIC, possibly based on the output of a trained ML model, may determine to transfer particular UE to other microcells as detailed in order to perform load balancing. The ML model may preemptively reassign UE to another microcell based the ML model indicating that congestion in a particular location or region is expected to increase. Therefore, prior to many UE receiving cellular network service from microcell 120-3, which may not meet the QoE defined by the SLA of at least some of the UE, UE are reassigned to other microcells for service. Such reassignment can improve the performance of the transferred UEs and also UEs that were not transferred to other microcells by resources being freed.

As an example of such an arrangement, assume that a food court of a shopping mall is south of microcell 120-3. Based on previous data indicates that the food court gets crowded at noon. The trained ML, ahead of noon, transitions some UE to other microcells to free bandwidth for other UE that are expected arrive at the food court. UE may be transferred if: 1) the UE will receive the same or a better service from another microcell; or 2) when transferred, the QoS parameters defined by the UE's SLA are expected to be met. As an example, transferring UE 503 to microcell 120-2 from microcell 120-3 may result in slower communication speeds, but may still be acceptable since the QoS parameters of the UE's SLA are met.

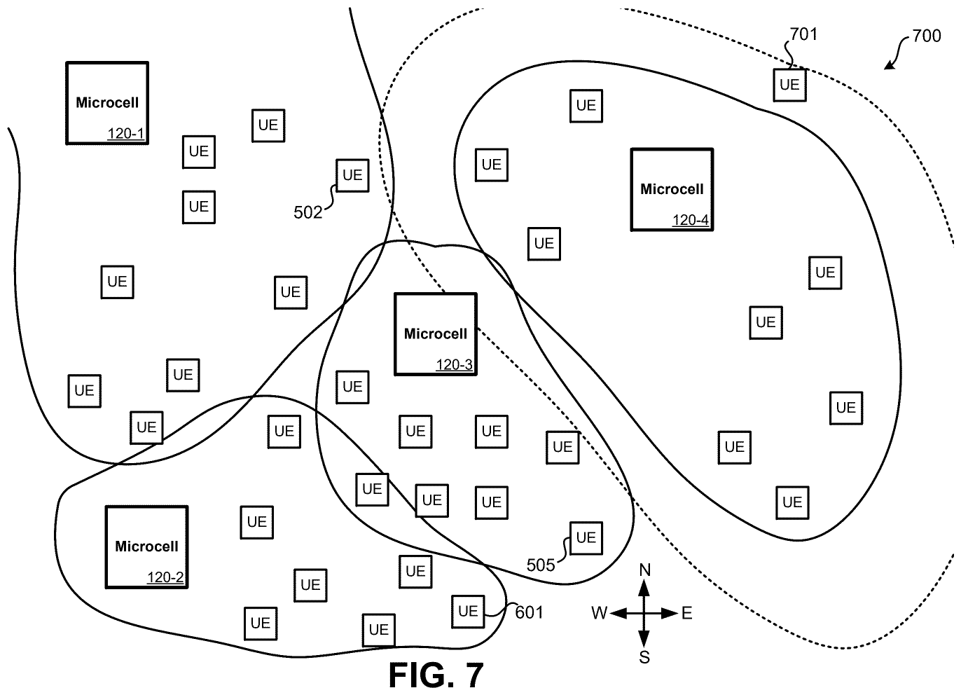

FIG. 7 illustrates a block diagram of an embodiment 700 of multiple cellular microcells providing cellular service to multiple UE in an environment using intelligent control and beamforming. While in embodiment 600 UE were transferred to another microcell, in embodiment 700, beamforming is performed by microcells 120 in order to alter the area to which service can be effectively provided. Referring back to FIG. 5, a large number of UE are south of microcell 120-3. A RIC of microcell 120-3 (or some other RIC operating for the environment) can preemptively (or reactively) alter the beamforming of multiple microcells.

For example, beamforming can be performed at microcell 120-2 such that UE typically serviced by microcell 120-3 have a similar signal strength with microcell 120-2. Beamforming can be performed by microcell 120-3 to not overlap with regions now adequately covered by other microcells. UE 505, for example, may previously been provided poor service by microcell 120-3, but after beamforming, better service provided by microcell 120-3. Further, the load on microcell 120-3 is decreased by UE, such as UE 502, now being serviced by another microcell via beamforming. In some implementation, beamforming adjustments are made dynamically in response to detected QoS degradation conditions. For example, when a high-density UE area is identified, microcells adjust their beam patterns to direct radio frequency energy toward the affected region, ensuring compliance with SLA-defined QoS parameters.

Accordingly beamforming can be performed to rebalance the number of UE served by each microcell of microcells 120. Such beamforming can be performed on its own or in conjunction with the rebalancing detailed in relation to embodiment 600 of FIG. 6.

A RIC, possibly based on the output of a trained ML model, may determine to perform beam shaping at one or more microcells in order to perform load balancing. The ML model may preemptively beam form to adjust to which UE service is provided by a particular microcell based the ML model indicating that congestion in a particular location or region is expected to increase. Therefore, prior to many UE receiving cellular network service from microcell 120-3, which may not meet the QoE defined by the SLA of at least some of the UE, beamforming can be performed.

As an example of such an arrangement, assume that a food court of a shopping mall is south of microcell 120-3. Based on previous data indicates that the food court gets crowded at noon. The RIC, based on a trained ML, ahead of noon, performs beamforming such that microcell 120-3 will provide service to a smaller region, while other UE will be served by other microcells at which beamforming was performed.

In alternate or in addition to performing beamforming and/or transferring UE among microcells, scheduling can be controlled by the one or more RICs in order to improve service. As an example, UE 701 may fall outside a region in which a strong signal strength is present (possibly due to an unintended consequence of beamforming). In order to improve service for the UE, such as to ensure that QoS of the UE's SLA is met, the RIC (e.g., of microcell 120-4) can provide scheduling priority to UE 701. Such scheduling priority can include UE 701 being provided more communication slots (e.g., physical resource blocks), access to frequency blocks at which UE 701 experiences the best signal strength, etc.

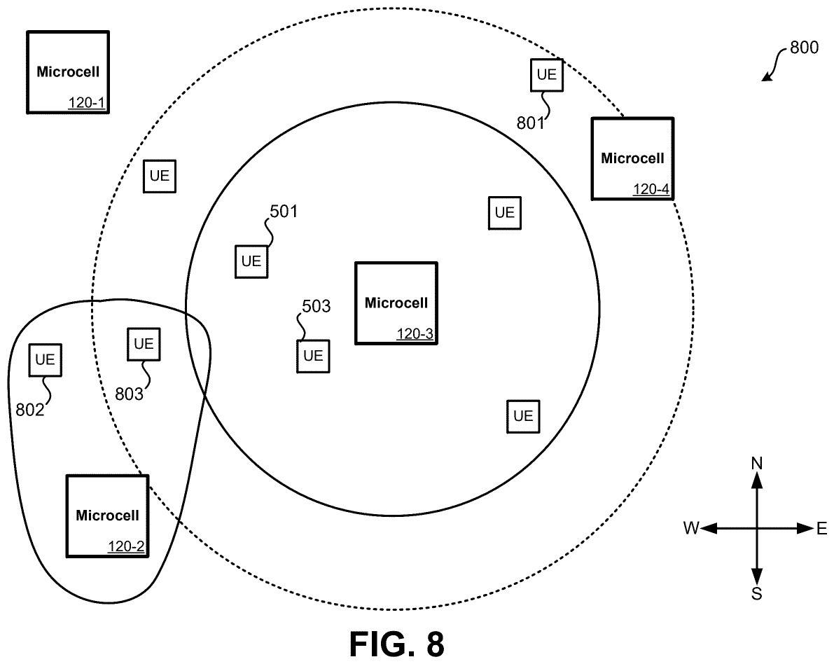

FIG. 8 illustrates a block diagram of an embodiment 800 of multiple cellular microcells providing cellular service to multiple UE in an environment using intelligent control, beamforming, and power savings. The one or more RICs of microcells 120 may determine, over time, that the number of UE requiring service greatly decreases at particular times of the day or days of the week. For example, the number of UE requiring service at a factory between 1-5 AM may be much lower than during business hours. The RIC may determine that a reduced number of microcells, possibly taking advantage of beam forming and other techniques detailed herein, can determine certain microcells 120 can be temporarily fully disabled (or have some number of antennas disabled).

In FIG. 8, microcell 120-1 and microcell 120-4 are fully disabled (e.g., powered off). UE that would otherwise be provided service by these microcells are now serviced by, for example, microcell 120-3. As an example, UE 801 can be serviced by microcell 120-3 and can be provided scheduling priority, if necessary, in order to meet the QoS requirements of UE 801.

For UE 802 and UE 803, beamforming can be performed by microcell 120-2 in order to provide service while microcell 120-1 is offline.

The one or more RICs may, over time, determine which microcells may not need to provide service during particular recurring days of the week or hours of the day. For example, in a factory, some microcells may provide service to only UE that are used during business hours. While other UE, such as microcell 120-3 in FIG. 8, may provide service to UE that remain operational outside of business hours, such as security cameras.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known, processes, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A method for predictive microcell beam energy shaping in a microcell network, the method comprising:
detecting, by the microcell network, a plurality of user equipments (UEs) in communication with the microcell network,
wherein the microcell network comprises a plurality of microcells spatially distributed in an environment such that radiation patterns of plurality of microcells collectively produce a microcell energy distribution field (MEDF) across the environment;
predicting, by the microcell network, a spatial UE capacity demand for microcell network capacity;
determining, by the microcell network, an adjustment to the MEDF to direct radio frequency energy toward the predicted spatial UE capacity demand; and
applying the adjustment to the MEDF by directing adjustment of beamforming and/or beam steering of one or more of the plurality of microcells.

2. The method of claim 1, wherein the applying the adjustment to the MEDF comprises coordinating beamforming and/or beam steering adjustments across at least two microcells of the plurality of microcells to collectively shape the MEDF toward the predicted spatial UE capacity demand.

3. The method of claim 1, wherein the applying the adjustment to the MEDF comprises dynamically reallocating radio frequency energy across the environment to balance network load among neighboring microcells.

4. The method of claim 1, wherein the applying the adjustment to the MEDF comprises directing phase and amplitude adjustments for individual antenna elements of the plurality of microcells to form collective beam patterns corresponding to the adjustment to the MEDF.

5. The method of claim 1, wherein the determining the adjustment to the MEDF comprises allocating additional radio frequency energy to UEs associated with higher quality of service (QoS) requirements as defined in their service level agreements (SLAs).

6. The method of claim 1, wherein the predicting the spatial UE capacity demand comprises using artificial intelligence and/or machine learning (AI/ML) models hosted on radio access network (RAN) intelligent controllers (RICs) of the microcell network to predict the spatial UE capacity demand.

7. The method of claim 1, wherein the predicting the spatial UE capacity demand comprises analyzing one or more of: real-time signal quality metrics; historical UE activity patterns; contextual environmental data; or real-time bandwidth usage metrics of the plurality of UEs.

8. The method of claim 1, wherein the predicting the spatial UE capacity demand comprises predicting regions of the environment expected to experience increased UE density based on historical trends and/or time-of-day patterns.

9. The method of claim 1, further comprising:
receiving real-time feedback, by the microcell network, subsequent to applying the adjustment to the MEDF, indicating updated locations of the plurality of UEs, bandwidth usage by the UEs, and/or QoS compliance rates for the UEs;
determining a further adjustment to the MEDF based on the real-time feedback; and
applying the further adjustment to the MEDF by directing further adjustment of beamforming and/or beam steering of one or more of the plurality of microcells.

10. A microcell network system for predictive microcell beam energy shaping, the microcell network system comprising:
a plurality of microcells spatially distributed in an environment, each microcell comprising one or more antennas configured to provide cellular communication to user equipment (UEs) in the environment, wherein the radiation patterns of the plurality of microcells collectively produce a microcell energy distribution field (MEDF) across the environment; and
one or more controllers configured to:
detect a plurality of UEs in communication with the microcell network;
predict a spatial UE capacity demand for microcell network capacity;
determine an adjustment to the MEDF to direct radio frequency energy toward the predicted spatial UE capacity demand; and
direct application of the adjustment to the MEDF by the plurality of microcells by directing adjustment of beamforming and/or beam steering of one or more antennas of the plurality of microcells.

11. The microcell network system of claim 10, wherein the one or more controllers comprise one or more radio access network (RAN) intelligent controllers (RICs).

12. The microcell network system of claim 11, wherein the one or more RICs host artificial intelligence and/or machine learning (AI/ML) models configured to predict the spatial UE capacity demand.

13. The microcell network system of claim 10, wherein the one or more controllers are configured to direct the application of the adjustment to the MEDF by coordinating beamforming and/or beam steering adjustments across at least two microcells of the plurality of microcells to collectively shape the MEDF toward the predicted spatial UE capacity demand.

14. The microcell network system of claim 10, wherein the one or more controllers are configured to direct the application of the adjustment to the MEDF by dynamically reallocating radio frequency energy across the environment to balance network load among neighboring microcells.

15. The microcell network system of claim 10, wherein the one or more controllers are configured to direct the application of the adjustment to the MEDF by directing phase and amplitude adjustments for individual antenna elements of the plurality of microcells to form collective beam patterns.

16. The microcell network system of claim 10, wherein the one or more controllers are configured to determine the adjustment to the MEDF by allocating additional radio frequency energy to UEs associated with higher quality of service (QoS) requirements as defined in their service level agreements (SLAs).

17. The microcell network system of claim 10, wherein the one or more controllers are configured to predict the spatial UE capacity demand by analyzing at least one of real-time signal quality metrics, historical UE activity patterns, contextual environmental data, or real-time bandwidth usage metrics of the plurality of UEs.

18. The microcell network system of claim 10, wherein the one or more controllers are configured to predict the spatial UE capacity demand by predicting regions of the environment expected to experience increased UE density based on historical trends and/or time-of-day patterns.

19. The microcell network system of claim 10, wherein the one or more controllers are further configured to:
receive real-time feedback indicating updated locations of the plurality of UEs, bandwidth usage by the UEs, and/or QoS compliance rates for the UEs;
determine a further adjustment to the MEDF based on the real-time feedback; and
direct application of the further adjustment to the MEDF by directing adjustment of beamforming and/or beam steering of one or more antennas of the plurality of microcells.

20. The microcell network system of claim 10, wherein the plurality of microcells is a plurality of cellular microcells in communication with a cellular core network.
